(19) United States
(12) Patent Application Publication
(10) Pub. No.: US 2010/0219381 A1
(43) Pub. Date: Sep. 2, 2010

(54) THERMALLY CONDUCTIVE AND ELECTRICALLY INSULATING THERMOPLASTIC COMPOUNDS

(75) Inventors: Kurt Jeschke, Duesseldorf (DE); Holger Schmidt, Dormagen (DE); Detlev Joachimi, Krefeld (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/671,106

(22) PCT Filed: Jul. 30, 2008
(86) PCT No.: PCT/EP2008/060018

§ 371 Date: May 19, 2010

(30) Foreign Application Priority Data
Aug. 8, 2007 (DE) 10 2007 037 316.5

(51) Int. Cl. H01B 1/12; H01B 1/24; C08K 3/38; C08K 3/22; C08K 3/04

(52) U.S. Cl. 252/511; 252/500; 252/519.33; 252/519.34; 524/404; 524/437; 524/599; 524/606

(57) ABSTRACT

The present invention relates to thermoplastic moulding compositions based on thermoplastics with an electrically insulating, thermally conductive filler and with a further thermally and electrically conductive filler, and to production of these and to their uses.

The present invention relates to thermoplastic moulding compositions based on thermoplastics with an electrically insulating, thermally conductive filler and with a further thermally and electrically conductive filler, and to production of these and to their uses.

Thermoplastic polymers have good electrical insulation properties and are therefore used for numerous electrical-industry applications. However, because they have low thermal conductivity they also act as thermal insulators, and this poses a problem in use for electrical components if a relatively large amount of heat is produced and has to be dissipated. The electrical and thermal conductivity of thermoplastics can be modified over a wide range by using additives. By way of example, addition of graphite increases both electrical and thermal conductivity. In contrast, there are only a few ways of increasing thermal conductivity while retaining the very low electrical conductivity required for electrical-industry applications.

The dissertation by Wolfgang Übler (University of Erlangen, 2002) on “Increasing the thermal conductivity of electrically insulating polymer materials” describes possible additives for increasing the thermal conductivity of compounded polymer materials while retaining their electrically insulating properties. It describes compositions composed of polymers, of aluminium oxide and of further organic additives, and also describes their thermal and electrical properties.

Addition of aluminium oxide (α-Al₂O₃) to increase the thermal conductivity of compounded thermoplastic materials is known and has been described in a number of applications.

DE10260098 A1 says that addition of aluminium oxide makes polyesters electrically insulating and thermally conductive. Further additives listed are low-molecular-weight and polymeric organic compounds.

WO 2003051971 A2 describes a compounded material composed of nylon-6 and also nylon-6,6 and 72.3% of aluminium oxide with thermal conductivity<0.5 W/mK for use in electrical equipment, floors and heat exchangers.

JP2004059638 A2 likewise describes moulding compositions for injection moulding, based on nylon-6, and also nylon-6,6 with aluminium oxide, and also the resultant mouldings with increased thermal conductivities.

JP 03 079663 A2 extends the group of aluminium-oxide-containing compounded materials to include nylon-4,6, and describes the combination of the filler with up to 30% of glass fibres for improving mechanical properties.

JP 2005 112908 A2 teaches the use of aluminium-oxide-filled polyamide as electrical insulator with good thermal conductivity. The resultant products are in particular described for the use of cable sheathing which retains its function under the following conditions: exposure to 2000 volts, over 50 hours.

JP-A 06 108400 describes the production of electrically insulating and thermally conductive compounded polyamide-aluminium-hydroxide materials suitable for the pressing of sheets. The parts produced feature particular Corona-resistance.

The use of graphite in compounded polyamide materials has been widely described, and emphasis is placed here on the electrical conductivity of the resultant moulding compositions.

JP-A 03 091556 describes compositions composed of polyamide which comprise from 1.0 to 20% of graphite and which have resistance of from 5.0 to 7.0 Ω/cm.

JP-A 62 227952 presents a material comprising graphite and glass fibre, the surface resistance of the material being only 2.2·10⁴Ω.

JP-A 60 108428 teaches in-situ production of a polyamide with addition of graphite to the monomer, and the resultant product after polymerization has electrical resistance of 0.027 Ω/cm.

JP-A 07 292245 says that addition of graphite also leads to an increase of electrical conductivity in compounded polyamide-polyimide materials.

JP-A 2003165904 deals with a compounded graphite-containing, electrically conductive polyamide material with particularly good impact resistance, achieved by adding rubber.

SU 1643568 presents glass-fibre-reinforced, graphite-containing, electrically conductive moulding compositions.

The electrical conductivities of the materials described in U.S. Pat. No. 6,228,288, based on polyamide and graphite, are intended to make them suitable for use for sensors.

Nanoscale graphite as additive in compounded polyamide materials also achieves electrical conductivity, as described in CN 1900162 A. The resultant materials are said to be particularly suitable for shielding with respect to electrostatic fields.

JP-A 57 193512 describes the production of electrically conductive polyamide fibres composed of a composition comprising graphite.

JP 2007 016093 A2 describes a composition composed of thermoplastic polymers and from 1 to 50% of graphite, with improved thermal conductivity: 1.6 W/mK.

Aluminium oxide is an inexpensive mineral with good thermal conductivity and, as described above, is suitable for the production of thermally conductive compounded thermoplastic materials. In contrast, graphite is used as additive for the production of electrically conductive moulding compositions. Graphite is also used to increase the thermal conductivity of moulding compositions, but because of electrical conductivity has not hitherto been used for thermally conductive compounded materials with electrically insulating properties.

However, it was an object of the present invention to provide thermoplastic moulding compositions which are based on polyamide and/or polyester and which have high thermal conductivity but which simultaneously feature electrically insulating properties.

Surprisingly, it has been found that addition of graphite to a thermoplastic moulding composition comprising aluminium oxide leads to a moulding composition which is not electrically conductive but instead is electrically insulating. This method can utilize the increase in thermal conductivity of the moulding compositions of the invention due to addition of graphite while retaining the desired electrically insulating properties.

The invention therefore provides thermoplastic moulding compositions based on
A) from 5 to 95% by weight of a thermoplastic polymer, preferably polyamide or polyester,
B) from 1 to 95% by weight, preferably from 20 to 80% by weight, particularly preferably from 40 to 70% by weight, of an electrically insulating, thermally conductive filler and
C) from 1 to 30% by weight, preferably from 5 to 20% by weight, particularly preferably from 10 to 15% by weight, of a further filler which is thermally and electrically conductive.

The moulding composition of the invention is an electrical insulator despite the addition of a further filler which is thermally and electrically conductive, preferably of graphite. This was an unpredictable finding, since when electrically conductive fillers are used as additive to thermoplastic moulding compositions the intention is usually to improve the electrical conductivity of the resultant moulding composition. Surprisingly, however, this known effect of the thermally and electrically conductive filler does not occur in the combination using an electrically insulating, thermally conductive filler, preferably aluminium oxide in the range of concentration described, preferably with use of graphite.

The invention therefore preferably provides thermoplastic moulding compositions comprising
A) from 5 to 95% by weight of a thermoplastic polymer, preferably polyamide or polyester, particularly preferably polyamide,
B) from 1 to 95% by weight, preferably from 20 to 80% by weight, particularly preferably from 40 to 70% by weight, of compounds of the elements of the 3rd main group with elements of the 5th or 6th main group of the Periodic Table of the Elements, or a mixture of these, preferably boron compounds or aluminium compounds, particularly preferably aluminium oxide or boron nitrides,
C) from 1 to 30% by weight, preferably from 5 to 20% by weight, particularly preferably from 10 to 15% by weight, of a thermally and electrically conductive filler, preferably allotropes of carbon, particularly preferably graphite.

According to the invention, the thermoplastic moulding compositions comprise, as component A), at least one thermoplastic polymer. Polyamide or polyester is preferably suitable. Nylon-6 (PA 6) and nylon-6,6 (PA 66) with relative solution viscosities of from 2.0 to 4.0 in m-cresol are particularly preferably suitable, particular preference being given to nylon-6 with a relative solution viscosity of from 2.3 to 2.6 in m-cresol, and also polybutylene terephthalate. The polymers of the invention can be produced by various processes and can be synthesized from different units, and, in the specific intended application, alone or in combination with processing aids, stabilizers, polymeric alloy partners (e.g. elastomers) or else reinforcing materials (e.g. mineral fillers or glass fibres), can be modified to give materials with specifically adjusted combinations of properties. Other suitable materials are blends with proportions of other polymers, preferably of polyethylene, polypropylene, or ABS, and one or more compatibilizers can be used here, if appropriate. The properties of the polyamides can be improved if necessary by adding elastomers, for example in respect of the impact resistance of the compounded polymer materials.

There are many known procedures for the production of polyamides, and as a function of desired end product here different monomer units or various chain regulators are used to adjust to a desired molecular weight, or else monomers having reactive groups are used for intended post-treatment processes.

Most of the industrially relevant processes for the production of polyamides proceed by way of polycondensation in the melt. In this context, the hydrolytic polymerization of lactams is also considered to be polycondensation.

According to the invention, preferred polyamides are semicrystalline polyamides, which can be produced from diamines and dicarboxylic acids and/or lactams having at least 5 ring members or from corresponding amino acids. Preferred starting materials that can be used are aliphatic and/or aromatic dicarboxylic acids, particularly preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, in particular aminocaproic acid, or the corresponding lactams. Copolyamides composed of a plurality of the monomers mentioned are included.

Particular preference is given to use of caprolactams, and very particular preference is given to use of ε-caprolactam.

According to the invention, special particular preference is moreover given to most of the compounded materials based on PA6 or on PA66, and to other compounded materials based on aliphatic and/or aromatic polyamides and, respectively, copolyamides, where there are from 3 to 11 methylene groups for each polyamide group in the polymer chain.

According to the invention, the thermoplastic polymers to be used as component A) in another preferred embodiment are those selected from the group of the polyesters, preferably polyalkylene terephthalates, particularly preferably of the polybutylene-terephthalates and polyethylene terephthalates, very particularly preferably of polybutylene terephthalate.

Preferred polyalkylene terephthalates can be produced using known methods from terephthalic acid (or from its reactive derivatives) and from aliphatic or cycloaliphatic diols having from 2 to 10 carbon atoms (Kunststoff-Handbuch, [Plastics Handbook] Vol. VIII, pp. 695 ff., Karl Hanser Verlag, Munich 1973).

Preferred polyalkylene terephthalates contain at least 80 mol %, preferably 90 mol %, based on the dicarboxylic acid, of terephthalic acid moieties, and at least 80 mol %, preferably at least 90 mol %, based on the diol component, of ethylene glycol moieties and/or 1,3-propanediol moieties and/or 1,4-butanediol moieties.

The preferred polyalkylene terephthalates can contain, alongside terephthalic acid moieties, up to 20 mol % of moieties of other aromatic dicarboxylic acids having from 8 to 14 carbon atoms, or moieties of aliphatic dicarboxylic acids having from 4 to 12 carbon atoms, examples being moieties of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid, cyclohexanedicarboxylic acid.

The preferred polyalkylene terephthalates can contain, alongside ethylene moieties or 1,3-propanediol moieties or 1,4-butanediol moieties, up to 20 mol % of other aliphatic diols having from 3 to 12 carbon atoms or of cycloaliphatic diols having from 6 to 21 carbon atoms, examples being moieties of 1,3-propanediol, 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol, 2-ethyl-1,3-hexanediol and 2-ethyl-1,6-hexanediol, 2,2-diethyl-1,3-propanediol, 2,5-hexanediol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-B-hydroxyethoxyphenyl)propane and 2,2-bis(4-hydroxypropoxyphenyl)propane.

Particular preference is given to polyalkylene terephthalates produced solely from terephthalic acid and its reactive derivatives (e.g. its dialkyl esters) and from ethylene glycol and/or from 1,3-propanediol and/or from 1,4-butanediol, and particular preference is given to polyethylene terephthalate and polybutylene terephthalate and mixtures of the said polyalkylene terephthalates.

Other preferred polyalkylene terephthalates are copolyesters which are produced from at least two of the abovementioned acid components and/or from at least two of the abovementioned alcohol components, and particularly preferred copolyesters are poly(ethylene glycol/1,4-butanediol) terephthalates.

The intrinsic viscosity of the polyalkylene terephthalates is generally about 0.3 cm³/g to 1.5 cm³/g, preferably from 0.4 cm³/g to 1.3 cm³/g, particularly preferably from 0.5 cm³/g to 1.0 cm³/g, in each case measured in phenol/o-dichlorobenzene (1:1 parts by weight) at 25° C.

The thermoplastic polyesters to be used according to the invention can also be used in a mixture with other polyesters and/or with further polymers.

In one preferred embodiment of the present invention, component B) is used in the form of fine needles, lamellae, spheres or irregularly shaped particles. Preferred particle sizes of component B) are from 0.1 to 100 μm, preferably from 1 to 8 μm. The thermal conductivity of the said component B) is from 10 to 400 W/mK, preferably from 30 to 250 W/mK. The component B) used particularly preferably comprises aluminium oxide.

Component C) is preferably used in the form of powder, flakes, pellets, pastes, compactates, extrudates or agglomerates. The particle size of component C) is preferably from 5 to 100 μm, particularly preferably from 10 to 30 μm.

It is particularly preferable that the component C) used comprises graphite.

In one preferred embodiment, the moulding compositions of the invention can also comprise, in addition to components A), B) and C)
D) from 0.01 to 10.0% by weight, preferably from 0.1 to 5.0% by weight, of further additives. Further additives of component D) are preferably stabilizers, particularly preferably UV stabilizers, heat stabilizers, gamma-radiation stabilizers, hydrolysis stabilizers, and also antistatic agents, emulsifiers, nucleating agents, plasticizers, processing aids, impact modifiers, dyes or pigments. The additives mentioned and other suitable additives are described by way of example in Plastics Additives Handbook, 5th Edition, Hanser-Verlag, Munich, 2001, pages 80-84, 546-547, 688, 872-874, 938, 966. The additives can be used alone or in a mixture or in the form of masterbatches.

Stabilizers preferred according to the invention are sterically hindered phenols and/or phosphites, hydroquinones, aromatic secondary amines, such as diphenylamines, substituted resorcinols, salicylates, benzotriazoles and benzophenones, and also various substituted representatives of the said groups and/or mixtures of these.

The UV stabilizers used preferably comprise various substituted resorcinols, salicylates, benzotriazoles or benzophenones.

Impact modifiers (elastomer modifiers) are very generally copolymers, preferably composed of at least two of the following monomers: ethylene, propylene, butadiene, isobutene, isoprene, chloroprene, vinyl acetate, styrene, acryloylnitrile and acrylates and, respectively, methacrylates having from 1 to 18 carbon atoms in the alcohol component. The copolymers can contain compatibilizing groups, e.g. maleic anhydride or epoxy.

Dyes or pigments to be used with preference can be inorganic pigments, particularly preferably titanium dioxide, ultramarine blue, iron oxide, zinc sulphide or carbon black, or else organic pigments, particularly preferably phthalocyanines, quinacridones, perylenes, or else dyes such as nigrosin and anthraquinones, or else other colorants.

The nucleating agents used preferably comprise sodium phenylphosphinate or calcium phenylphosphinate, aluminium oxide or silicon dioxide or talc, particular preference being given to talc.

In another preferred embodiment, the moulding compositions of the invention can also comprise, in addition to components A), B), C) and D), or instead of component D)
E) from 0.01 to 5.0% by weight, preferably from 0.05 to 1.0% by weight, of lubricants and/or mould-release agents. Preferred lubricants and/or mould-release agents are long-chain fatty acids (e.g. stearic acid), its salts (e.g. Ca stearate or Zn stearate), and also its ester derivatives or amide derivatives (e.g. ethylenebisstearylamide), montan waxes (e.g. esters of montanic acids with ethylene glycol), and also low-molecular-weight polyethylene waxes and low-molecular-weight polypropylene waxes. Lubricants and/or mould-release agents particularly preferred according to the invention are those from the group of the esters or amides of saturated or unsaturated aliphatic carboxylic acid having from 8 to 40 carbon atoms with saturated aliphatic alcohols or amines having from 2 to 40 carbon atoms.

In another preferred embodiment, the moulding compositions of the invention can also comprise, in addition to components A), B), C), D) and E), or instead of D) or instead of E) or instead of D) and E)
F) from 1 to 60% by weight, preferably from 5 to 40% by weight, particularly preferably from 10 to 30% by weight, of fillers or reinforcing materials, preferably glass fibres.

One particularly preferred embodiment of the present invention comprises
A) polyamide or polyester
B) aluminium oxide or boron nitride
C) graphite
and also, if appropriate F) glass fibres.

Particular preference is given to a combination of
A) polyamide or polybutylene terephthalate
B) aluminium oxide
C) graphite
and also, if appropriate, F) glass fibres.

The invention further provides a process for the production of electrically insulating moulding compositions which comprise graphite and which at the same time have high thermal conductivity, characterized in that these comprise
A) from 5 to 95% by weight of a thermoplastic polymer, preferably polyamide or polyester,
B) from 1 to 95% by weight, preferably from 20 to 80% by weight, particularly preferably from 40 to 70% by weight, of an electrically insulating, thermally conductive filler and
C) from 1 to 30% by weight, preferably from 5 to 20% by weight, particularly preferably from 10 to 15% by weight, of graphite.

The invention further provides the use of graphite in combination with a compound of the elements of the 3rd main group with elements of the 5th or 6th main group of the Periodic Table of the Elements, for the production of thermoplastic moulding compositions which are thermally conductive and at the same time electrically insulating, preferably based on polyamide or polyester, particularly preferably on polyamide. It is preferable to use aluminium oxide or boron nitride, and it is particularly preferable to use aluminium oxide.

However, the present invention also provides the use of graphite for raising thermal conductivity while retaining the electrically insulating properties of thermoplastic moulding compositions which comprise compounds of the elements of the 3rd main group with elements of the 5th or 6th main group of the Periodic Table of the Elements, preferably with a reduced proportion of the said component in the thermoplastic moulding composition.

The moulding compositions of the invention are produced by known processes by mixing of the components in the polymer melt. The appropriate proportions by weight of the components are mixed. The mixing (compounding) of the components preferably takes place at temperatures of from 220 to 360° C. by combining, mixing, kneading, extruding or rolling of the components together, particularly preferably by compounding in a counter-rotating twin-screw extruder or Buss kneader. It can be advantageous to premix individual components. It can moreover be advantageous to produce mouldings or semifinished products directly from a physical mixture (dryblend) produced at room temperature (preferably from 0 to 40° C.) and comprising premixed components and/or individual components. The resultant moulding compositions can be processed by extrusion or injection moulding.

The mouldings to be produced according to the invention from the moulding compositions can by way of example be used in the motor vehicle industry, electrical industry, electronics industry, telecommunications industry, information technology industry, or computer industry, or in households or in sport, or in medicine or in the entertainment industry. In particular, moulding compositions of the invention can be used for applications which require high thermal conductivity. Examples of such applications are the use for components in electronics or display technology (light-emitting diodes).

### EXAMPLES

In order to demonstrate the improvements described according to the invention, compounding was first used to prepare appropriate plastics moulding compositions. The individual components were mixed in a ZSK 32 compounder twin-screw extruder from Coperion Werner & Pfleiderer (Stuttgart, Germany) at temperatures of from 260 to 290° C., extruded into a waterbath, and cooled until they were pelletizable and pelletized. The pellets were dried (generally for two days at 70° C. in a vacuum oven) and then processed in an Arburg SG370-173732 injection-moulding machine at temperatures of from 270 to 300° C. to give test specimens measuring 60×40×4 mm³ and 60×60×2 mm³.

The nanoflash method was used to measure thermal conductivities and thermal diffusivities on test specimens of dimensions 60×60×2 mm³, perpendicularly with respect to the direction of flow of the melt, by a method based on ASTM E1461, using a Laser Nanoflash LFA 447 from Netzsch Gerätebau GmbH.

The IEC 60093 method was used to measure electrical conductivities on test specimens of dimensions 60×40×4 mm. The distance between the conductive silver lacquer electrodes applied was 50 mm.

The following compositions are processed in the manner described above.

TABLE 1
Examples of the moulding compositions of the invention

| | | | Reference |
|---|---|---|---|
| | Example 1 | Example 2 | example |
| A) Thermoplastic, % | 34.9 | 34.9 | 34.9 |
| B) Aluminium oxide, % | 50 | 35 | 65 |
| C) Graphite, % | 15 | 15 | 0 |
| E) Wax, % | 0.1 | 0.1 | 0.1 |
| F) Glass fibres, % | 0 | 15 | 0 |
| Electrical conductivity, | <10⁻⁶ | <10⁻⁶ | <10⁻⁶ |
| S/m | | | |
| Thermal conductivity, | 1.67 | 1.21 | 1.17 |
| W/mK | | | |
| Thermal diffusivity, m²/s | 7.9 × 10⁻⁷ | 6.1 × 10⁻⁷ | 5.2 × 10⁻⁷ |

### Materials Used:

Thermoplastic, e.g. nylon-6, linear, with relative solution viscosity of 2.4 for a 1% strength solution in m-cresol.
Aluminium oxide, e.g. Martoxid MPS2 from Martinswerk GmbH
Graphite, e.g. EG31 from SGL Carbon GmbH
Wax, e.g. Licowax E Flakes from Clariant GmbH
Glass fibres, e.g. CS7928 from Lanxess Deutschland GmbH.

1-15. (canceled)

16. A thermoplastic molding composition comprising:
A) from 5 to 95% by weight of a thermoplastic polymer;
B) from 1 to 95% by weight of a first filler, said first filler being electrically insulating and thermally conductive;
and
C) from 1 to 30% by weight of a second filler, said second filler being electrically conductive and thermally conductive.

17. The thermoplastic molding composition according to claim 16, wherein the thermoplastic polymer component A) comprises a polyamide or a polyester.

18. The thermoplastic molding composition according to claim 16, wherein the first filler component B) comprises a compound selected from the group of the elements of the Periodic Table consisting of the 3rd main group, 5th main group, 6th main group, and mixtures of these.

19. The thermoplastic molding composition according to claim 16, wherein the second filler component C) comprises an allotrope of carbon.

20. The thermoplastic molding composition according to claim 16, further comprising:
D) one or more additives.

21. The thermoplastic molding composition according to claim 16, further comprising:
E) a lubricant and/or a mould-release agent.

22. The thermoplastic molding composition according to claim 16, further comprising:
F) glass fibers.

23. A process for the production of the thermoplastic molding composition according to claim 16, comprising:
admixing the thermoplastic polymer A), the first filler B), and the second filler C).

24. The process according to claim 23, wherein said admixing is carried out at a temperature of from 220 to 360° C.

25. A process for the production of components with improved thermal conductivity, comprising:
moulding the thermoplastic molding composition according to claim 16.

26. A process for the production of a graphite-containing molding composition which is electrically insulating and thermally conductive, comprising:
incorporating the thermoplastic molding composition according to claim 16 into said graphite-containing molding composition.

27. A process for the production of a thermoplastic molding composition which is thermally conductive and electrically insulating, comprising:
combining graphite and a compound selected from the group of the elements of the Periodic Table consisting of the 3rd main group, 5th main group, 6th main group, and mixtures of these with the thermoplastic molding composition,
wherein said thermoplastic molding comprises a polyamide and/or a polyester material.

28. The process according to claim 27, wherein said compound is aluminum compounds, boron compounds, aluminum oxide, boron nitride, or mixtures thereof.

29. A process for raising the thermal conductivity while retaining the electrically insulating properties of a thermoplastic molding composition, comprising:
admixing the thermoplastic molding composition with a first filler component B) which includes a compound selected from the group of the elements of the Periodic Table consisting of the 3rd main group, 5th main group, 6th main group, and mixtures of these.

30. The thermoplastic molding composition according to claim 18, wherein said compound is aluminum compounds, boron compounds, aluminum oxide, boron nitride, or mixtures thereof.

31. The thermoplastic molding composition according to claim 19, wherein said allotrope of carbon is graphite.

32. The thermoplastic molding composition according to claim 20, wherein said one or more additives are selected from the group consisting of UV stabilizers, heat stabilizers, gamma-radiation stabilizers, hydrolysis stabilizers, antistatic agents, emulsifiers, nucleating agents, plasticizers, processing aids, impact modifiers, dyes, pigments, mixtures thereof, and mixtures thereof in the form of a masterbatch.
